(19) United States
(12) Patent Application Publication
(10) Pub. No.: US 2012/0036794 A1
(43) Pub. Date: Feb. 16, 2012

(54) BATHING AREA SURROUND

(76) Inventor: Peter Dabrowski, Macomb, MI (US)

(21) Appl. No.: 13/281,401

(22) Filed: Oct. 25, 2011

Related U.S. Application Data
(63) Continuation of application No. 11/971,224, filed on Jan. 9, 2008, now Pat. No. 8,082,608.

(51) Int. Cl. A47K 3/14; B23P 11/00

(52) U.S. Cl. 52/35; 29/446

(57) ABSTRACT

An exemplary bathing area surround includes a surround wall and a tub basin having a tub bottom and a plurality of tub sides. A tub ledge extends from the tub basin transverse to the tub sides. A tub flange extends from the tub ledge away from the tub bottom. A tongue extends from one of the tub ledge and the surround wall. The other of the tub ledge and the surround wall defines a groove for receiving the tongue. The tongue biases the surround wall toward the tub flange when the tongue is received within the groove.

### REFERENCE TO RELATED APPLICATIONS

This application is a continuation of U.S. patent application Ser. No. 11/971224, which was filed 9 Jan. 2008 and is incorporated herein by reference.

### BACKGROUND

This disclosure relates generally to securing panels of a bathing area surround to a tub basin.

Moisture splashing or leaking from a bathing area during a bath or shower may damage adjacent areas, such as bathroom walls or floors. Bathing area surrounds protect the adjacent areas by containing moisture in the bathing area. Some bathing areas, such as tubs or showers, include bathing surround panels designed to contain moisture to a tub basin. However, such panels are often relatively large, difficult to manipulate into position, and prone to leaking at panel joints.

### SUMMARY

An exemplary bathing area surround includes a surround wall and a tub basin having a tub bottom and a plurality of tub sides. A tub ledge extends from the tub basin transverse to the tub sides. A tub flange extends from the tub ledge away from the tub bottom. A tongue extends from one of the tub ledge and the surround wall. The other of the tub ledge and the surround wall defines a groove for receiving the tongue. The tongue biases the surround wall toward the tub flange when the tongue is received within the groove.

An exemplary method of installing a tub surround includes flexing a flange to bias a surround wall in a first direction away from a tub basin while moving the surround wall in a second direction transverse the first direction.

An exemplary bathing area surround includes a surround wall moveable between an uninstalled position and an installed position relative to a tub. A surround flange extends outwardly from the surround wall. Separate tongues extend downwardly from the surround flange. The separate tongues are moveable between a less biased position and a more biased position. The tub has a tub bottom. Tub sides extend upwardly from the tub bottom. A tub ledge extends outwardly from some of the tub sides. The tub ledge defines separate grooves configured to receive a corresponding one of the plurality of separate tongues. A tub flange extends upwardly from the tub ledge. The separate grooves are defined by at least an outer groove wall and an inner groove wall. The outer groove wall is aligned with the tub flange. The inner groove wall is angled relative to the tub flange. The separate tongues are each in the more biased position when the plurality of separate tongues are received within the plurality of separate grooves and the surround wall is in an installed position relative to the tub.

### BRIEF DESCRIPTION OF THE DRAWINGS

These and other features of the present invention can be best understood from the following specification and drawings, the following of which is a brief description:

FIG. 1 illustrates a perspective view of an example bathing area surround;

FIG. 2 illustrates a close up view of one of the surround wall sections in an installed position;

FIG. 3 illustrates a front view of the FIG. 2 section in an installed position;

FIG. 4A illustrates a sectional view through line 4-4 of FIG. 3 when the panel is in an installed position;

FIG. 4B illustrates a sectional view through line 4-4 FIG. 3 when the panel is in an uninstalled position; and

FIG. 5 illustrates a sectional view through line 5-5 of FIG. 3.

### DETAILED DESCRIPTION OF THE PREFERRED EMBODIMENT

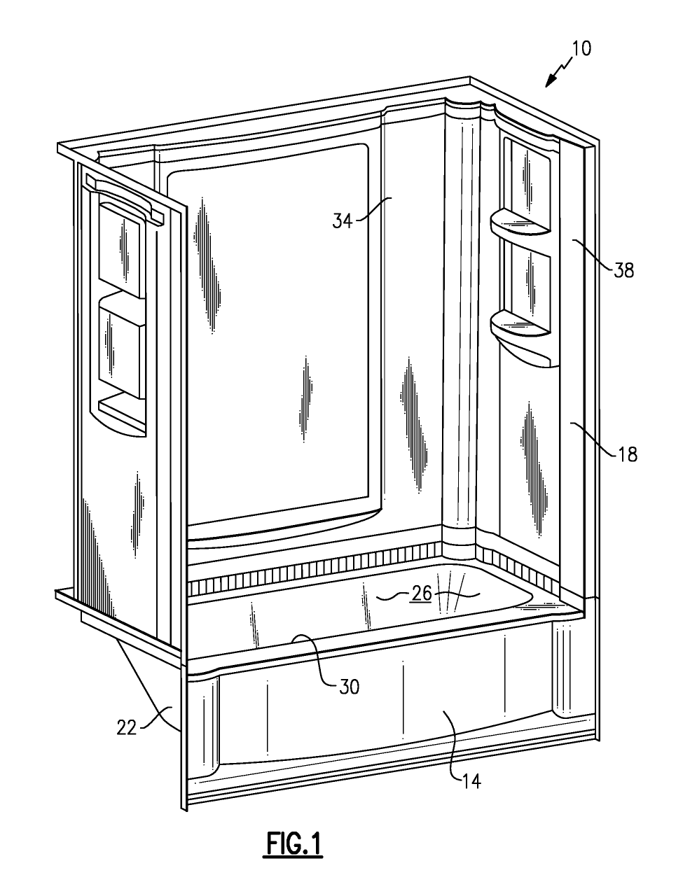

FIG. 1 illustrates an example bathing area surround 10 including a tub basin 14 and a surround wall 18. The tub basin includes a tub bottom 22, tub sides 26, and a tub ledge 30. The bathing area surround 10 is shown in an installed position on the tub ledge 30. The surround wall 18 includes multiple surround wall sections, such as a surround wall back 34 and sides 38. In this example, the tub basin 14, the surround wall back 34, and the surround walls sides 38 are each separate pieces that are attached together to form the bathing area surround 10.

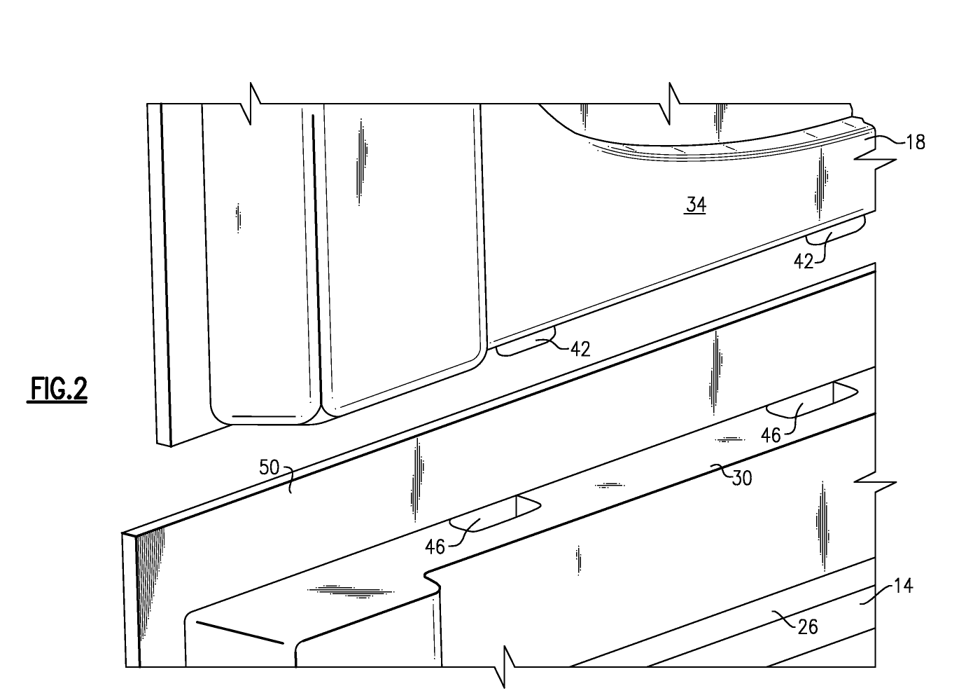

FIG. 2 illustrates the surround wall back 34 in an unassembled position. The surround wall back 34 includes a tongue 42 for receipt within a groove 46 defined by the tub ledge 30. A tub flange 50 extends from the tub ledge 30 along the rear of the surround wall back 34.

The tub basin 14 and the surround wall 18 are formed from vacuum formed polystyrene panels, for example. Vacuum forming also forms the tongue 42 and the groove 46, which secures the surround wall 18 relative the tub basin 14. Accordingly, the features for securing the surround wall 18 near the tub basin 14 can be made entirely with vacuum forming operations. In some examples, a water jet cutter shapes the perimeter of the tub basin 14 and the surround wall 18 after vacuum forming the individual panels. The water jet cutter may help shape the tongue 42 and cutouts or other details within the bathing surround 10.

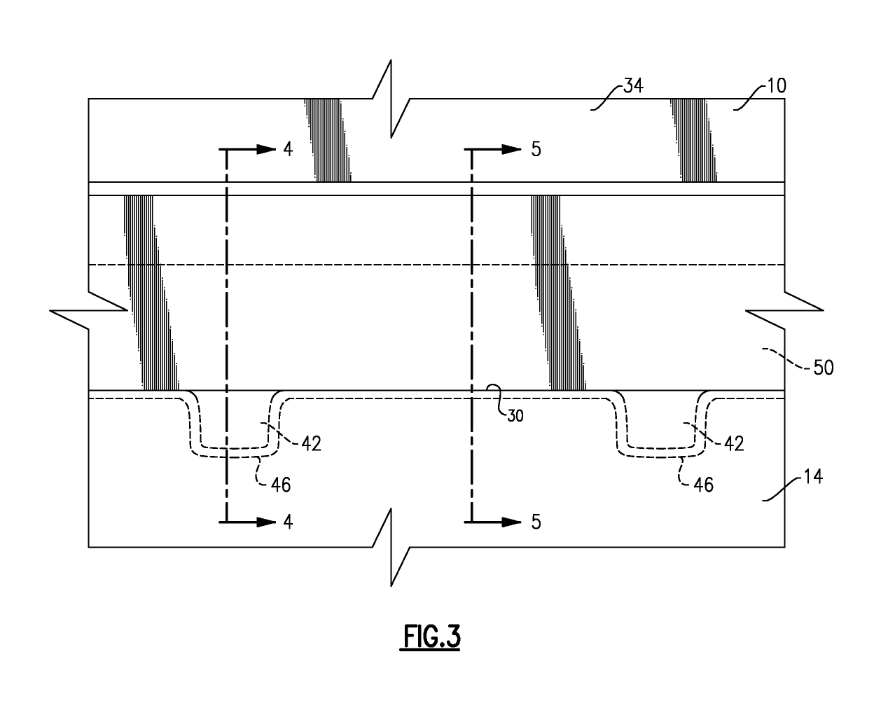

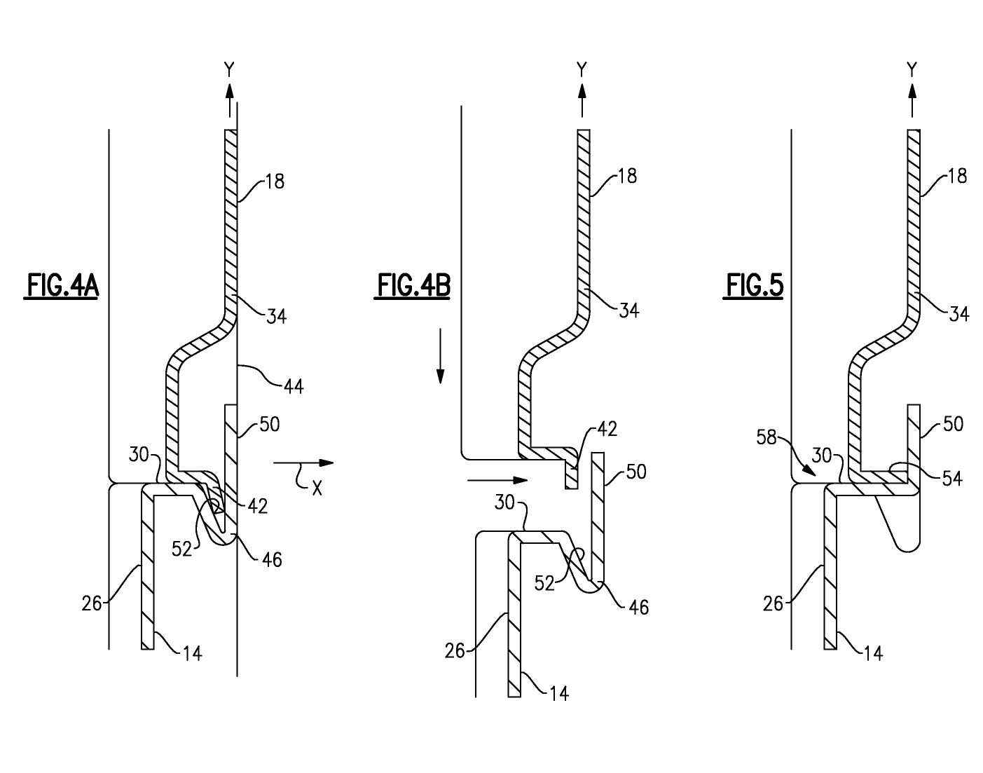

Referring now to FIG. 3, in the installed position, the surround wall back 34 contacts the tub basin 14 at the tub ledge 30 when the tongue 42 is received with in the groove 46. The tongue 42 extends into the groove 46 beyond the tub ledge 30. As shown in FIG. 4A, the tongue 42 helps bias portions of the surround wall back 34 toward the tub flange 50. More specifically, moving the tongue 42 to the installed position within the groove 46 tends to move the tongue 42 away from the tub side 26 in direction X as the tongue 42 slides down a surface 52 defining a portion of the groove 46. The surface 52 angles away from the tub basin 14 to direct the tongue 42 away from the tub basin 14.

The tongue 42 also helps bias portions of the surround wall 18 against a bathroom wall 44. The tongue 42 pulls portions of the surround wall 18 toward the bathroom wall 44 as the tongue 42 moves down the surface 52. As known, the bathroom wall 44 may include studs that are covered by the surround wall 18.

FIG. 4B shows the tongue 42 prior to moving to the installed position of FIG. 4A. As shown, the tongue 42 is aligned relative an axis Y defined generally by the surround wall back 34 in an uninstalled position, but flexes away from the axis Y when moving toward an installed position. In another example, the tongue 42 is transverse the axis Y when in the uninstalled position, but moves toward the axis Y as the tongue 42 slides down the surface 52 to the installed position.

Referring now to FIG. 5, moving the tongue 42 away from the tub side 26 moves a surround flange 54 formed with the surround wall back 34 closer to the tub flange 50. Moving the surround flange 54 toward the tub flange 50 beneficially helps seal an interface 58 of the surround wall back 34 and the tub ledge 30. In some examples, an installer may run a bead of caulk along the interface 58. The installer may use mechanical fasteners, such as nails or screws, to hold the surround wall 18 position against the tub ledge 30, but generally no fasteners are needed to hold the surround flange 54 against the tub flange 50. The mechanical fasteners are also located apart from the interface 58 near the upper portions of the surround wall 18 away from the tub basin 14.

The surround wall sides 38 install to the tub ledge 30 in a similar manner. Although shown as the tongue 42 formed with the surround wall back 34, those skilled in the art and having the benefit of this disclosure will understand that other examples may include the surround wall back 34 including the groove 46 and the tongue 42 extending from the tub ledge 30.

Although a preferred embodiment of this invention has been disclosed, a worker of ordinary skill in this art would recognize that certain modifications would come within the scope of this invention. For that reason, the following claims should be studied to determine the true scope and content of this invention.

I claim:

1. A bathing area surround, comprising:
a surround wall;
a tub basin having a tub bottom and a plurality of tub sides;
a tub ledge extending from the tub basin transverse to the plurality of tub sides; and
a tub flange extending from the tub ledge away from the tub bottom, wherein a tongue extends from one of the tub ledge and the surround wall, and the other of the tub ledge and the surround wall defines a groove for receiving the tongue, wherein the tongue biases the surround wall toward the tub flange when the tongue is received within the groove.

2. The bathing area surround of claim 1, wherein moving the tongue into the groove moves the tongue from a less biased position to a more biased position to bias the surround wall.

3. The bathing area surround of claim 1, wherein the tub ledge supports the surround wall.

4. The bathing area surround of claim 1, including a surround flange extending transversely from the surround wall.

5. The bathing area surround of claim 1, including a second tongue extending from the other of the tub ledge and the surround wall, the second tongue separate from the tongue, and configured to be received within a second groove separate from the groove.

6. The bathing area surround of claim 1, wherein the groove is at least partially defined by a first surface facing the tub basin and a second surface facing away from the tub basin, the tongue biased by the first surface or the second surface when the tongue is received within the groove.

7. The bathing area surround of claim 6, wherein the first surface is angled relative to the tub flange and the second surface is parallel to the tub flange.

8. The bathing area surround of claim 1, wherein the tongue is angled relative to an interior face of the surround wall when the tongue is received within the groove and the surround wall is in an installed position.

9. The bathing area surround of claim 1, wherein the tongue biases the surround wall toward an interior bathroom wall.

10. The bathing area surround of claim 1, wherein moving the tongue within the groove biases the surround wall away from the tub flange.

11. The bathing area surround of claim 1, wherein the tongue is configured to contact a side of the groove to urge the surround wall toward the tub flange when the surround wall is in the installed position.

12. A method of installing a tub surround, comprising:
flexing a flange to bias a surround wall in a first direction away from a tub basin while moving the surround wall in a second direction transverse the first direction.

13. The method of claim 12, including establishing a biasing force using an angled surface to move a tongue further from the tub basin.

14. The method of claim 13, wherein the surround wall includes the tongue.

15. The method of claim 12, wherein moving the flange into a groove causes the flange to bias the surround wall.

16. The method of claim 12, wherein moving the flange into a groove causes the flange to bend relative to the surround wall.

17. A bathing area surround, comprising:
a surround wall moveable between an uninstalled position and an installed position relative to a tub;
a surround flange extending outwardly from the surround wall;
a plurality of separate tongues extending downwardly from the surround flange, each of the plurality of separate tongues moveable between a less biased position and a more biased position;
a tub bottom of the tub;
a plurality of tub sides extending upwardly from the tub bottom;
a tub ledge extending outwardly from at least some of the plurality of tub sides, the tub ledge defining a plurality of separate grooves each configured to receive a corresponding one of the plurality of separate tongues;
a tub flange extending upwardly from the tub ledge, wherein each of the plurality of separate grooves are defined by at least an outer groove wall and an inner groove wall, the outer groove wall aligned with the tub flange, the inner groove wall angled relative to the tub flange, wherein the plurality of separate tongues are each in the more biased position when the plurality of separate tongues are received within the plurality of separate grooves and the surround wall is in an installed position relative to the tub.
